(19) United States
(12) Patent Application Publication
(10) Pub. No.: US 2010/0108108 A1
(43) Pub. Date: May 6, 2010

(54) SUBSTRATE MOUNTING TABLE, SUBSTRATE PROCESSING APPARATUS AND METHOD FOR TREATING SURFACE OF SUBSTRATE MOUNTING TABLE

(75) Inventors: Kazuichi Hayashi, Yamanashi (JP); Hidenori Miyoshi, Yamanashi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Tokyo Electron Limited, Tokyo (JP)

(21) Appl. No.: 12/532,480

(22) PCT Filed: Mar. 14, 2008
(86) PCT No.: PCT/JP08/54814

§ 371 Date: Nov. 16, 2009

(30) Foreign Application Priority Data
Mar. 22, 2007 (JP) 2007-073992

(51) Int. Cl. B08B 3/00

(52) U.S. Cl. 134/115 R

(57) ABSTRACT

A substrate mounting table includes a mounting table main body whose top surface and side surface are covered with an upper cover member. Surface treatment is performed partially to a substrate surrounding region disposed outside a substrate mounting region on a top surface of the upper cover member, so that the substrate surrounding region is smoother than the substrate mounting region. The substrate mounting region is covered by a wafer when the wafer is mounted thereon. Thus, for instance, a metal component generated upon removal of a metal oxide film from the substrate is not easily adhered on the mounting table, and is easily removed if adhered.

### FIELD OF THE INVENTION

The present invention relates to a substrate processing apparatus which performs, for example, a cleaning process for removing a metal oxide film on a surface of a metal film formed on a substrate; and also relates to a substrate mounting table and a method for treating a surface of the substrate mounting table.

### BACKGROUND OF THE INVENTION

In order to meet the recent demands for increase in lifetime, a miniaturization of wirings and a higher speed of a semiconductor device, Cu (copper) or a Cu alloy having lower electric resistance and higher electromigration resistance has been employed as a main material for a metal wiring instead of conventionally employed Al (aluminum). When such a Cu-based metal wiring is formed on a semiconductor substrate such as a semiconductor wafer, a damascene method is generally employed because patterning Cu by plasma etching or the like is difficult.

To achieve electric connection between, e.g., a lower Cu-based metal wiring and an upper Cu-based metal wiring by using the damascene method, a via hole is first formed in an interlayer dielectric film formed on the lower Cu-based metal wiring. Then, the Cu-based metal is coated on the entire surface of the wafer by a plating method or the like so that the via hole is filled with the Cu-based metal. Thereafter, a CMP (Chemical Mechanical Polishing) is used to remove unnecessary Cu-based metal on the interlayer dielectric film so that only the Cu-based metal is left in the via hole. Subsequently, the upper Cu-based metal wiring is formed by coating the Cu-based metal on the entire wafer surface again. In this way, the lower Cu-based metal wiring and the upper Cu-based metal wiring are electrically connected with each other through the via hole.

If the surface of the lower Cu-based metal wiring is kept exposed to the atmosphere after the via hole is formed in the interlayer dielectric film, the surface would be oxidized, resulting in a formation of a native oxide film (metal oxide film) of the Cu-based metal on that surface. Especially, since Cu tends to be easily oxidized, the formation of the metal oxide film is highly likely to occur.

If the via hole is filled with the Cu-based metal while the oxide film still exists in the via hole, contact resistance between the lower Cu-based metal wiring and the Cu-based metal filled in the via hole may be increased due to the presence of the oxide film therebetween. In such case, fine electric characteristics of a semiconductor device to be formed on the wafer may not be obtained. Thus, the metal oxide film formed on the Cu-based metal wiring needs to be removed before the Cu-based metal is filled in the via hole.

As a conventional technique for removing such a metal oxide film, there is known a method of cleaning the surface of a metal wiring such as a Cu-based metal wiring by using carboxylic acid such as formic acid or the like (see, for example, Patent Document 1). By performing a cleaning process (dry cleaning) on the surface of the metal wiring by using such organic acid, the metal oxide film formed on the surface of the metal wiring can be reduced and removed.

Patent Document 1: Japanese Patent Laid-open Application No. 2002-270609

Patent Document 2: Japanese Patent Laid-open Application No. 2004-356624

However, the above-mentioned drying cleaning has a problem in that a part of a metal component generated as a result of the reduction of the metal oxide film on the surface of the metal wiring is dispersed in a space within a processing chamber after separated from the surface of the metal wiring layer and finally adhered to various components in the processing chamber. Especially, the dispersed metal component is highly likely to be adhered to an exposed peripheral surface of a mounting table that is not covered by the wafer.

Further, as such a cleaning process is repeated, the metal component dispersed onto the surface of the mounting table may be deposited, resulting in a formation of an undesired metal layer thereon. If the wafer drying cleaning process is performed in this state, the metal layer adhered to the surface of the mounting table may be etched by the organic acid used in the cleaning process, which may result in particle generation. The particles thus produced are highly likely to be adhered to a portion of the wafer surface again. Such metal contamination may affect subsequent wafer processing, causing a problem such as a failure to obtain a standard quality of the semiconductor device formed on the wafer.

As a solution to this problem, a cleaning operation has been conventionally performed by an operator when deposit of the metal component is accumulated on the surface of the mounting table to a certain extent. Such a mounting table cleaning operation has been generally carried out manually by way of washing away the metal deposit on the surface of the mounting table after opening, e.g., a cover of the processing chamber (wet cleaning). In case that the mounting table or members constituting the surface thereof are taken out and cleaned in the aforementioned way, the mounting table and the like has to be re-installed in the processing chamber after the surface of the mounting table is cleaned and it is also required to check if the processing chamber is normally operable or not. Thus, it takes some time to carry out the mounting table cleaning operation, during which the wafer processing cannot be performed.

Therefore, if the mounting table cleaning operation is frequently performed, overall throughput may be deteriorated. Moreover, the problem of metal contamination due to the metal deposit on the surface of the mounting table may be also caused in a film forming process for forming a metal film such as a Cu film on the wafer.

Accordingly, to prevent the occurrence of the metal contamination due to the wafer cleaning process, the surface treatment of the mounting table needs to be performed to make the surface of the mounting table as smooth as possible so that the metal component is hardly adhered thereto and can be removed readily even if the metal component is adhered.

Conventionally, however, it has been mainly focusing on preventing the adhesion of the deposit on the wafer surface after the deposit is peeled off from the mounting table surface. Thus, there has been an attempt to, for example, intensionally roughen the surface of the mounting table rather than to smoothen it. For example, Patent Document 2 discloses the mounting table made of quartz glass, on which a deposit such as metal cannot be easily adhered. However, Patent Document 2 also discloses intensional roughening of the surface of the mounting table to suppress peeling off of the deposit such as metal or the like from the surface of the mounting table, thus reducing the number of cleaning operations for the mounting table.

However, as the surface roughness of the mounting table increases, the deposit such as metal or the like adhered on that surface becomes difficult to peel off, and as the deposit becomes more difficult to peel off, a metal layer is more easily formed. Thus, the mounting table cleaning operation needs to be carried out more frequently to prevent the occurrence of wafer metal contamination which may be caused by the above-described cleaning process.

Moreover, as the surface roughness of the mounting table increases, it takes more time and effort for the metal film adhered on the surface thereof to be removed.

Conventionally, once the metal deposit is adhered to the mounting table, it could not be removed unless the operator puts in effort to wash it away with a cleaning solution, which may impose a burden on the operator and result in deterioration of processing efficiency.

As stated above, the conventional mounting table does not have a sufficient countermeasure to the occurrence of the metal contamination that might be caused in the wafer cleaning process.

### SUMMARY OF THE INVENTION

In view of the problems set forth above, it is an object of the present invention to provide a substrate mounting table capable of suppressing adhesion of a metal component generated in performing, e.g., a cleaning process for removing a metal oxide film on a substrate, and also capable of easily removing a metal component even if the metal component is adhered to the substrate.

In accordance with one aspect of the present invention to solve the problems described above, there is provided a substrate mounting table of a substrate processing apparatus that performs a cleaning process of removing a metal oxide film (e.g., a native oxide film made of such as copper oxide or the like) on a surface of a metal film (e.g., a film including copper) formed on a substrate, including: a mounting table main body for mounting the substrate thereon, wherein a top surface of the mounting table main body includes a substrate mounting region, which is covered by the substrate when the substrate is mounted on the mounting table main body, and a substrate surrounding region, which is disposed outside the substrate mounting region and has a surface treated by a partial surface treatment such that the substrate surrounding region is smoother than the substrate mounting region.

Further, there is provided a substrate mounting table of a substrate processing apparatus that performs a cleaning process of removing a metal oxide film on a surface of a metal film formed on a substrate, including: a mounting table main body, at least a top surface of which is covered with a cover member, wherein a top surface of the cover member includes a substrate mounting region, which is covered by the substrate when the substrate is mounted on the cover member, and a substrate surrounding region, which is disposed outside the substrate mounting region and has a surface treated by a partial surface treatment such that the substrate surrounding region is smoother than the substrate mounting region.

In accordance with the present invention, the surface of the substrate surrounding region on the top surface of the mounting table main body or the cover member is treated by the partial surface treatment to further smoothen the substrate surrounding region exposed without being covered by the substrate. Thus, when the cleaning process is performed to remove the metal oxide film (e.g., copper oxide) on the substrate, a metal component (e.g., copper) generated by the reduction of the metal oxide film may be suppressed from being easily adhered to the substrate surrounding region with which the metal component tends to contact even though the metal component is dispersed thereto. Moreover, even if metal deposit is accumulated on the substrate surrounding region, the deposit can also be easily removed. Accordingly, an adhesion amount of the metal component on the surface of the substrate mounting table is surely reduced, so that the frequency of the substrate mounting table cleaning process can be reduced. Further, the metal component is easily removed even if adhered, so that the time for completing the substrate mounting table cleaning process can also be shortened.

Especially, since the substrate surrounding region is exposed without being covered by the substrate and is a horizontal region closest to the substrate among the entire surface of the substrate, the metal component is highly likely to float and adhere to the substrate surrounding region. In this regard, an effect of preventing the adhesion of the metal component to the entire surface of the substrate mounting table can be efficiently improved by smoothing this substrate surrounding region selectively. Moreover, in case that the top surface of the mounting table main body is covered by the cover member, only the cover member can be separated and cleaned when the dispersed metal component is adhered thereto. Therefore, the time required for the cleaning process of the substrate mounting table can be further shortened.

Further, the mounting table main body may include a side surface treated by the partial surface treatment such that the side surface of the mounting table main body has a surface roughness identical to that of the substrate surrounding region. Moreover, a side surface of the mounting table main body may be also covered by a side portion of the cover member and the side portion of the cover member may have a surface treated by the partial surface treatment such that the surface of the side portion of the cover member has a surface roughness identical to that of the substrate surrounding region.

Since the metal component is possibly adhered to the mounting table main body and/or the side surface of the cover member, the partial surface treatment is performed on their surfaces. Therefore, the effect of preventing the adhesion of the metal component to the entire surface of the substrate mounting table can be efficiently improved.

In such cases, a surface roughness of the surface treated by the partial surface treatment may be equal to or less than 1/10 of a surface roughness of the substrate mounting region. For example, a surface roughness Ra, which is an arithmetic average roughness, of the surface treated by the partial surface treatment is equal to or less than 0.1 μm. Since the partial surface treatment is performed to obtain a higher level of smoothness, the effect of preventing the adhesion of the metal component to the surface treated by the partial surface can be efficiently improved.

The surface treated by the partial surface treatment may be made of a quartz member having a surface treated by a fire polish process. Further, the surface treated by the partial surface treatment may be made of an aluminum member having a surface treated by a nonporous anodic oxidation process. By performing the above processes, a surface roughness Ra (an arithmetic average roughness) of the surface treated by the partial surface treatment can be equal to or less than 0.1 μm.

Further, in case that the cleaning process is a so-called drying cleaning process performed in a gaseous atmosphere, the metal component generated in the cleaning process is likely to float in the vicinity of the substrates. Thus, by performing the partial surface treatment to further smooth the substrate surrounding region, the effect of preventing the adhesion of the metal component to the entire surface of the substrate mounting table can be further improved.

In accordance with another aspect of the present invention to solve the above-mentioned problems, there is provided a substrate processing apparatus for performing a cleaning process for removing a metal oxide film on a surface of a metal film formed on a substrate, including: a vacuum evacuable processing chamber; a substrate mounting table installed in the processing chamber; and a gas supply unit for supplying at least a cleaning processing gas into the processing chamber; and a gas inlet unit, installed in the processing chamber, for introducing a gas from the gas supply unit toward the substrate on the mounting table, wherein the substrate mounting table includes a mounting table main body for mounting the substrate thereon.

Herein, a top surface of the mounting table main body includes a substrate mounting region, which is covered by the substrate when the substrate is mounted on the mounting table main body, and a substrate surrounding region, which is disposed outside the substrate mounting region and has a surface treated by a partial surface treatment such that the substrate surrounding region is smoother than the substrate mounting region.

Further, there is provide a substrate processing apparatus for performing a cleaning process for removing a metal oxide film on a surface of a metal film formed on a substrate, including: a vacuum evacuable processing chamber; a substrate mounting table installed in the processing chamber; and a gas supply unit for supplying at least a cleaning processing gas into the processing chamber; and a gas inlet unit, installed in the processing chamber, for introducing a gas from the gas supply unit toward the substrate on the mounting table, wherein the substrate mounting table includes a mounting table main body, at least a top surface of which is covered by a cover member.

Herein, a top surface of the cover member includes a substrate mounting region, which is covered by the substrate when the substrate is mounted on the cover member, and a substrate surrounding region, which is disposed outside the substrate mounting region and has a surface treated by a partial surface treatment such that the substrate surrounding region is smoother than the substrate mounting region.

In accordance with the present invention, the cleaning process for removing the metal oxide film (e.g., copper oxide) on the substrate mounting on the substrate mounting table by supplying a cleaning processing gas (e.g., an organic acid containing gas) toward the substrate while controlling an internal pressure of the processing chamber. At this time, the surface of the substrate surrounding region on the top surface of the mounting table main body or the cover member is treated by the partial surface treatment to further smoothen the substrate surrounding region exposed without being covered by the substrate. Thus, a metal component (e.g., copper) generated by the reduction of the metal oxide film may be suppressed from being easily adhered to the substrate surrounding region with which the metal component tends to contact even if the metal component is dispersed thereto. Moreover, even if metal deposit is accumulated on the substrate surrounding region, the deposit can also be easily removed. Accordingly, an adhesion amount of the metal component on the surface of the substrate mounting table is surely reduced, so that the frequency of the substrate mounting table cleaning process can be reduced. Further, the metal component is easily removed even if adhered, so that the time for completing the substrate mounting table cleaning process can also be shortened.

Further, a processing chamber inner wall may have a surface exposed to an inside of the processing chamber, and the surface is made of an aluminum member having a surface treated by a nonporous anodic oxidation process. Moreover, the gas inlet unit may have a surface exposed to an inside of the processing chamber, and the surface is made of an aluminum member having a surface treated by a nonporous anodic oxidation process. The dispersed metal component may be adhered to the surface of the processing chamber inner wall and/or the surface of the gas inlet unit (e.g., a shower head). Therefore, by performing the nonporous anodic oxidation process on their surfaces as well as the substrate mounting table, the adhesion of the metal component thereon can be effectively prevented.

In accordance with still another aspect of the present invention to solve the above-mentioned problems, there is provided a substrate treatment method for a substrate mounting table of a substrate processing apparatus that performs a cleaning process of removing a metal oxide film on a surface of a metal film formed on a substrate, wherein the substrate mounting table includes a mounting table main body for mounting the substrate thereon, and wherein a top surface of the mounting table main body includes a substrate mounting region, which is covered by the substrate when the substrate is mounted on the mounting table main body, and a substrate surrounding region, which is disposed outside the substrate mounting region.

The substrate treatment method includes: performing a partial surface treatment on a surface of the substrate surrounding region such that the substrate surrounding region is smoother than the substrate mounting region.

Further, there is provided a substrate treatment method for a substrate mounting table of a substrate processing apparatus that performs a cleaning process of removing a metal oxide film on a surface of a metal film formed on a substrate, wherein the substrate mounting table includes a mounting table main body, at least a top surface of which is covered with a cover member, and wherein a top surface of the cover member includes a substrate mounting region, which is covered by the substrate when the substrate is mounted on the cover member, and a substrate surrounding region, which is disposed outside the substrate mounting region.

The substrate treatment method includes: performing a partial surface processing on a surface of the substrate surrounding region such that the substrate surrounding region is smoother than the substrate mounting region.

In accordance with the present invention, the surface of the substrate surrounding region on the top surface of the mounting table main body or the cover member is treated by the partial surface treatment to further smoothen the substrate surrounding region exposed without being covered by the substrate. Thus, a metal component dispersed to the substrate surrounding region with which the metal component tends to contact may be suppressed from being easily adhered to the substrate surrounding region. Moreover, even if metal deposit is accumulated on the substrate surrounding region, the deposit can also be easily removed. Accordingly, an adhesion amount of the metal component on the surface of the substrate mounting table is surely reduced, so that the frequency of the substrate mounting table cleaning process can be reduced. Further, the metal component is easily removed even if adhered, so that the time for completing the substrate mounting table cleaning process can also be shortened.

Further, the surface treatment method described above may include performing a partial surface treatment on a side surface of the mounting table main body such that the side surface of the mounting table main body has a surface roughness identical to that of the substrate surrounding region. Further, a side surface of the mounting table main body may also be covered by a side portion of the cover member, and the surface treatment method described above may include performing a partial surface treatment on a surface of the side portion of the cover member such that the surface of the side portion of the cover member has a surface roughness identical to that of the substrate surrounding region.

Since the metal component is possibly adhered to the mounting table main body and/or the side surface of the cover member, the partial surface treatment is performed on their surfaces. Therefore, the effect of preventing the adhesion of the metal component to the entire surface of the substrate mounting table can be efficiently improved.

In such cases, a surface roughness of the surface treated by the partial surface treatment may be equal to or less than 1/10 of a surface roughness of the substrate mounting region. Further, a surface roughness Ra, which is an arithmetic average roughness, of the surface treated by the partial surface treatment, may be equal to or less than 0.1 μm.

Since the partial surface treatment is performed to obtain a higher level of smoothness, the effect of preventing the adhesion of the metal component to the surface treated by the partial surface can be efficiently improved.

In accordance with still another aspect of the present invention to solve the above-mentioned problems, there is provided a substrate mounting table of a substrate processing apparatus for performing a film forming process for forming a metal film on a substrate or a cleaning process for removing a metal oxide film on the metal film, including: a first member having a substrate mounting surface for mounting the substrate thereon; and a second member, installed to surround the substrate mounting surface, having a substrate surrounding region disposed outside the substrate mounting region, wherein the substrate mounting surface and the substrate surrounding surface are treated by a partial surface treatment such that their surface roughnesses Ra, which is an arithmetic roughness, are equal to or less than 0.1 μm.

Further, there is provided a substrate mounting table of a substrate processing apparatus for performing a film forming process for forming a metal film on a substrate or a cleaning process for removing a metal oxide film on the metal film, including: a mounting table main body, at least a top surface of which is covered with a cover member, wherein the cover member includes: a first cover member having a substrate mounting surface for mounting the substrate thereon; and a second cover member, installed to surround the substrate mounting surface, having a substrate surrounding surface disposed outside the substrate mounting surface, wherein the substrate mounting surface and the substrate surrounding surface are treated by a partial surface treatment such that their surface roughnesses Ra, which is an arithmetic roughness, are equal to or less than 0.1 μm.

In accordance with the present invention, a metal component (e.g., copper) generated when the film forming process or the cleaning process is performed on the substrate may be suppressed from being easily adhered to the substrate surrounding surface and can be easily removed even if the metal component is deposited on the substrate surrounding surface. Further, the metal component is also hardly adhered to the substrate mounting surface even if the metal component is dispersed into a space between the substrate and the substrate mounting surface. Moreover, even if metal deposit is accumulated on the substrate surrounding region, the deposit can also be easily removed. Accordingly, an adhesion amount of the metal component on the surface of the substrate mounting table is surely reduced, so that the frequency of the substrate mounting table cleaning process can be reduced. Further, the metal component is easily removed even if adhered, so that the time for completing the substrate mounting table cleaning process can also be shortened.

Further, in accordance with the present invention, the mounting table main body is divided into the first member including the substrate mounting surface having the substrate mounting region and the second member including the substrate surrounding surface having the substrate surrounding region. Therefore, the partial surface processing can be easily performed on the substrate mounting surface as well as the substrate surrounding surface. Moreover, the cover member of the mounting table main body is divided into the first cover member including the substrate mounting surface having the substrate mounting region and the second cover member including the substrate surrounding surface having the substrate surrounding region. Thus, the partial surface processing can be easily performed on the substrate mounting surface as well as the substrate surrounding surface.

Further, the second member of the mounting table main body may include a side surface treated by the partial surface treatment such that the side surface of the second member of the mounting table main body has a surface roughness identical to that of the substrate surrounding region. Further, a side surface of the mounting table main body is also covered by a side portion of the second cover member and the side portion of the second cover member has a surface treated by the partial surface treatment such that the surface of the side portion of the second cover member has a surface roughness identical to that of the substrate surrounding region.

Since the metal component is possibly adhered to the mounting table main body and/or the side surface of the cover member, the partial surface treatment is performed on their surfaces. Therefore, the effect of preventing the adhesion of the metal component to the entire surface of the substrate mounting table can be efficiently improved.

Further, each of the surfaces treated by the partial surface treatment may be made of a quartz member having a surface having a surface treated by a fire polish process. Further, each of the surfaces treated by the partial surface treatment is made of an aluminum having a surface treated by a nonporous anodic oxidation process. By performing the above processes, a surface roughness Ra (an arithmetic average roughness) of each of the surfaces treated by the partial surface treatment can be equal to or less than 0.1 μm.

In the present specification, 1 sccm is (10⁻⁶/60)m³/sec.
In accordance with the present invention, a metal component cannot be easily adhered to a surface of a mounting table main body even when a cleaning process for removing a metal oxide film or a film forming process for forming a metal film is performed on a substrate. Moreover, even if metal deposit is accumulated, the deposit can be easily removed. Accordingly, an adhesion amount of the metal component on the surface of the substrate mounting table is surely reduced, so that the frequency of mounting table cleaning process can be reduced. Also, the metal component is easily removed even if adhered, so that the time for completing the substrate mounting table cleaning process can be shortened.

### BRIEF DESCRIPTION OF THE DRAWINGS

FIG. 1 is a vertical cross sectional view illustrating a configuration example of a cleaning processing apparatus in accordance with an embodiment of the present invention.

FIG. 2 presents a vertical cross sectional view illustrating a film structure of a wafer on which a cleaning process is performed by the cleaning processing apparatus shown in FIG. 1.

FIG. 3 sets forth a partial cross sectional view illustrating a configuration example of a mounting table shown in FIG. 1.

FIG. 4 depicts a partial cross sectional view illustrating another configuration example of the mounting table shown in FIG. 1.

### DETAILED DESCRIPTION OF THE EMBODIMENTS

Hereinafter, embodiments of the present invention will be described in detail with reference to the accompanying drawings. Throughout the specification and drawings, like reference numerals are used for like or corresponding parts, and redundant description thereof will be omitted.

(Configuration Example of a Cleaning Processing Chamber)

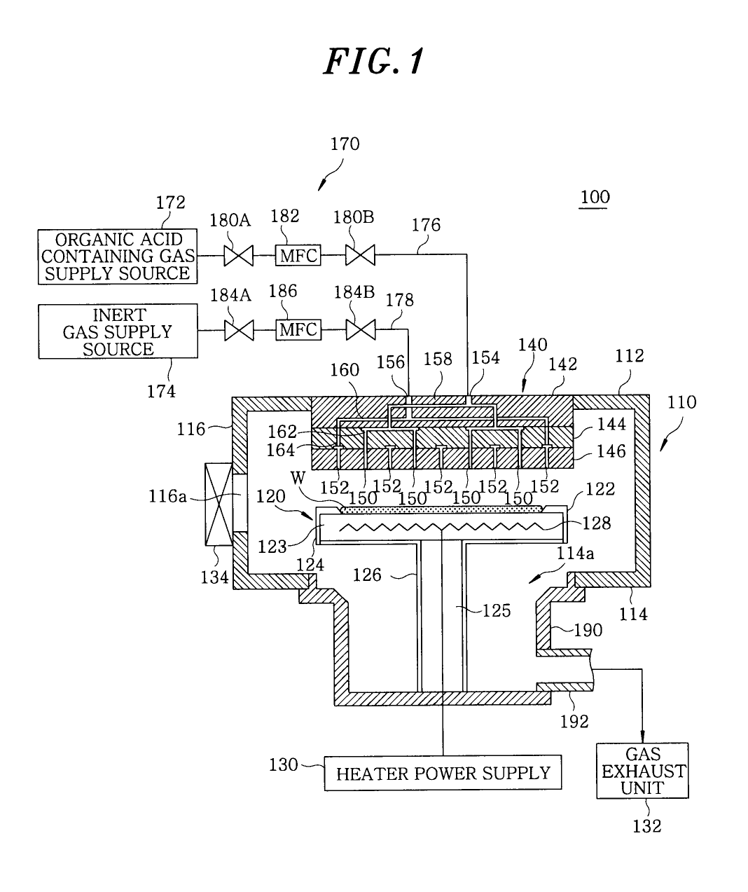

First, a configuration example of a substrate processing apparatus in accordance with an embodiment of the present invention will be explained with reference to the accompanying drawings. FIG. 1 is a vertical cross sectional view showing a schematic configuration of a cleaning processing apparatus 100 used as the substrate processing apparatus in accordance with the present embodiment. The cleaning processing apparatus 100 includes an airtightly sealed processing chamber 110 having a substantially cylindrical shape and is configured to accommodate a wafer W in the processing chamber 110 and perform a cleaning process for removing a metal oxide film formed on the wafer W.

A shower head 140 serving to introduce a gas from a gas supply unit 170 toward the substrate on a mounting table 120 is installed at a ceiling wall 112 of the processing chamber 110. The shower head 140 includes an upper block body 142, an intermediate block body 144 and a lower block body 146.

The lower block body 146 is provided with alternately arranged first gas injection openings 150 for discharging a first processing gas and second gas injection openings 152 for injecting a second processing gas. The upper block body 142 is provided with, on its top surface, a first gas inlet port 154 for introducing the first processing gas and a second gas inlet port 156 for introducing the second processing gas.

The upper block body 142 is provided with, in its inside, a plurality of first upper gas channels 158 branched off from the first gas inlet port 154 and extended in horizontal and vertical directions; and a multitude of second upper gas channels 160 branched off from the second gas inlet port 156 and extended in horizontal and vertical directions. Further, the intermediate block body 144 is provided with, in its inside, a plurality of first intermediate gas channels 162 respectively communicating with the first upper gas channels 158 and extending in horizontal and vertical directions; and a multitude of second intermediate gas channels 164 respectively communicating with the second upper gas channels 160 and extending in horizontal and vertical directions. The first intermediate gas channels 162 communicate with the first gas injection openings 150, while the second intermediate gas channels 164 communicate with the second gas injection openings 152.

The cleaning processing apparatus 100 in accordance with the present embodiment includes the gas supply unit 170.

The gas supply unit 170 includes an organic acid containing gas supply source 172 for supplying an organic acid containing gas as a cleaning processing gas; and an inert gas supply source 174 for supplying an inert gas. In the present embodiment, carbonic acid is used as the organic acid. Examples of the carbonic acid may be oxalic acid, formic acid, acetic acid, citric acid, succinic acid, and so forth. Further, a N₂ (nitrogen) gas, an Ar (argon) gas, or the like may be used as the inert gas.

The organic acid containing gas supply source 172 is connected with an organic acid containing gas supply line 176, and the inert gas supply source 174 is connected with an inert gas supply line 178. A valve 180A, a mass flow controller (MFC) 182 and a valve 180B are installed on the organic acid containing gas supply line 176 in sequence from the upstream side thereof. In the same manner, a valve 184A, a mass flow controller (MFC) 186 and a valve 184B are installed on the inert gas supply line 178 in sequence from the upstream side thereof.

The organic acid containing gas supply line 176 is connected to the first gas inlet port 154 provided in the upper block body 142 of the shower head 140, and the inert gas supply line 178 is connected to the second gas inlet port 156.

With this configuration, the organic acid containing gas from the organic acid containing gas supply source 172 is introduced into the shower head 140 via the organic acid containing gas supply line 176 and the first gas inlet port 154 of the shower head 140, and then injected into the processing chamber 110 from the first gas injection openings 150 after flowing through the first upper gas channels 158 and the first intermediate gas channels 162. In the same manner, the inert gas from the inert gas supply source 174 is introduced into the shower head 140 via the inert gas supply line 178 and the second gas inlet port 156 of the shower head 140, and then injected into the processing chamber 110 from the second gas injection openings 152 after flowing through the second upper gas channels 160 and the second intermediate gas channels 164.

The shower head 140 in accordance with the present embodiment is of a post-mix type such that the organic acid containing gas and the inert gas are independently supplied into the processing chamber 110. Accordingly, in a cleaning process, it may be possible to supply the organic acid containing gas and the inert gas alternately as well as simultaneously, and it may be also possible to supply either one of them. Further, a pre-mix type shower head may be employed instead of the shower head 140. Moreover, only the organic acid gas containing gas supply line 176 may be installed without the inert gas supply line 178.

A circular opening 114a is provided in a central portion of a bottom wall 114 of the processing chamber 110, and a gas exhaust chamber 190 extending downward from the bottom wall 114 to cover the opening 114a. A gas exhaust unit 132 is connected to a sidewall of the gas exhaust chamber 190 via a gas exhaust pipe 192. By operating the gas exhaust unit 132, the inside of the processing chamber 110 can be depressurized to a specific vacuum level.

Installed at a sidewall 116 of the processing chamber 110 are a loading/unloading port 116a through which the wafer W is loaded into or unloaded from the processing chamber 110; and a gate valve 134 configured to open or close the loading/unloading port 116a.

A mounting table 120 for mounting the wafer W thereon is provided in the processing chamber 110. The mounting table 120 includes a circular plate-shaped mounting table main body 122 for holding the wafer W thereon and a cylindrical supporting column 125 supporting the mounting table main body 122. A lower end of the supporting column 125 is installed in a bottom portion of the processing chamber 110 by using bolts or the like, whereby the mounting table 120 is fixed to the inside of the processing chamber 110. The mounting table main body 122 includes, for example, a circular plate-shaped main body plate 123; and an upper cover member (main body cover member) 124, which covers a top surface (substrate mounting surface) and a side surface (side surface) of the main body plate 123. In the mounting table main body 122 having the upper cover member 124, the top surface and the side surface of the upper cover member 124 serves as a top surface (substrate mounting surface) and a side surface (side surface) of the mounting table main body 122.

Further, the mounting table main body 122 may have only the main body plate 123 without the upper cover member 124. In such case, the main body plate 123 itself serves as the mounting table main body 122, such that the top surface and the side surface of the main body plate 123 also serve as the top surface (substrate mounting surface) and the side surface (side surface) of the mounting table main body 122. Further, a lower cover member 126 for covering both a bottom surface of the main body plate 123 and a surface of the supporting column 125 may be additionally installed. In this configuration, the entire surface of the mounting table 120 is covered with the upper cover member 124 and the lower cover member 126.

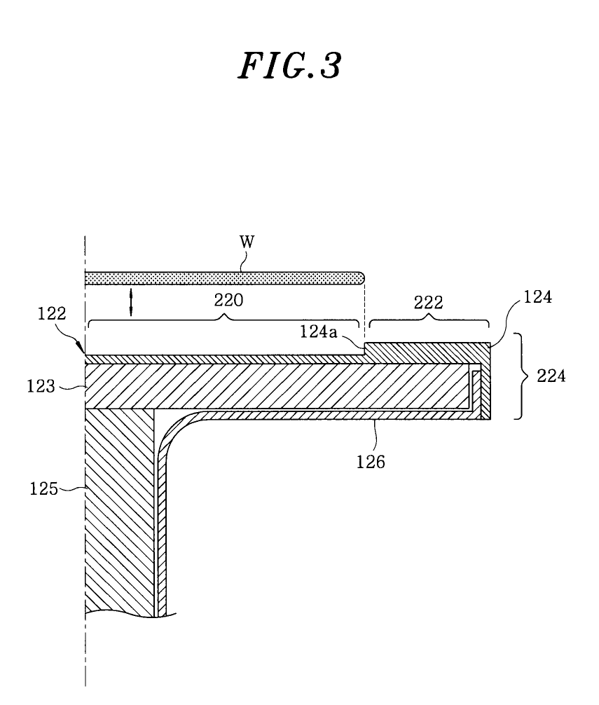

Here, specific configuration examples of the cover members 124 and 126 will be explained with reference to the relevant drawings. FIG. 3 is an enlarged vertical cross sectional view illustrating a part of the mounting table 120. As shown in FIG. 3, the lower cover member 126 is configured to partially or entirely cover a side surface of the main body plate 123 as well as the bottom surface of the main body plate 123 and the surface of the supporting column 125. The side portion of the upper cover member 124 is preferably configured to cover a radially outermost side of lower cover member 126. In this configuration, since the side surface of the main body plate 123 is covered by the lower cover member 126 and the upper cover member 124 placed thereon, the entire surface of the mounting table 120 can be covered by the upper cover member 124 and the lower cover member without any gap present therebetween.

Further, as illustrated in FIG. 3 for example, a stepped portion 124a may be formed between a substrate mounting region 220 and a substrate surrounding region 222 on the top surface (substrate mounting surface) of the upper cover member 124, so that the substrate mounting region 220 for mounting the wafer W thereon is positioned lower than the substrate surrounding region 222 around it. This configuration allows the wafer W to be mounted on a preset position on the mounting table 120.

Preferably, the main body plate 123 and the upper cover member 124 included in the mounting table main body 122 as well as the supporting column 125 and the lower cover member 126 may be formed of a material having high heat resistance and high corrosion resistance against a cleaning processing gas, e.g., organic acid, to which these components are exposed during the cleaning process. Further, the upper cover member 124 may be preferably formed of a material to which a floating metal component (e.g., copper) generated in the cleaning process is hardly adhered. Such a material may be, for example, a quartz member (quartz glass) such as quartz (SiO₂). It is empirically known that compared to Si, quartz is a material to which a metal component such as Cu is not easily adhered and quartz has a high corrosion resistance to the organic acid and a high heat resistance. Likewise, the main body plate 123 constituting the mounting table main body 122 and the supporting column 125 may be made of a quartz member such as quartz glass.

Further, a heater 128 is embedded in the main body plate 123 of the mounting table main body 122. The heater 128 generates heat depending on a power supplied from a heater power supply 130, whereby the temperature of the wafer W is controlled.

Further, the mounting table 120 further includes a wafer support mechanism (not shown) capable of moving up and down while holding the wafer W thereon so as to transfer the wafer W to/from a transfer mechanism such as a transfer arm. The wafer support mechanism includes, for example, three wafer supporting pins (lifter pins), and each wafer supporting pin is configured to be protruded above and retracted below the surface of the mounting table main body 122 through a hole provided through the mounting table main body 122.

(Specific Example of Cleaning Process)

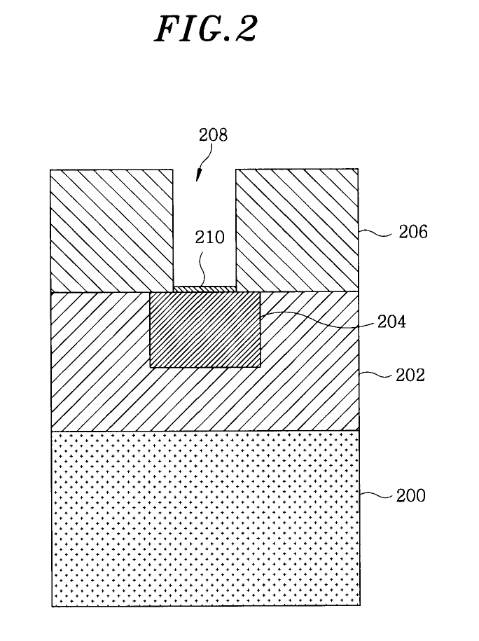

Now, a cleaning process performed by the cleaning processing apparatus 100 in accordance with the above-described embodiment will be explained. The cleaning processing apparatus 100 performs a cleaning process on a wafer W having a film structure as illustrated in FIG. 2, for example. The wafer W has an insulating film 202 formed on a bare Si substrate 200; a metal wiring layer 204 formed in the insulating film 202; and an interlayer dielectric film 206 formed on the insulating film 202. In the present embodiment, the metal wiring layer 204 is made of Cu. Further, the insulating film 202 and the interlayer dielectric film 206 are made of, e.g., SiO₂ (silicon oxide) or a Low-k material having a lower dielectric constant than SiO₂.

Devices such as MOS (Metal Oxide Semiconductor) transistors and/or a wiring layer electrically connecting these devices may be formed between the bare Si substrate 200 and the insulating film 202. In such a case, the wiring layer is electrically connected with, e.g., the metal wiring layer 204.

As for the wafer W, the interlayer dielectric film 206 on the metal wiring layer 204 is selectively etched and thus provided with a via hole 208. By filling the via hole 208 with metal, an upper metal wiring (not shown) to be formed on the interlayer dielectric film 206 layer is allowed to be electrically connected with the metal wiring layer 204.

However, if the via hole 208 is formed in the interlayer dielectric film 206, a part of the surface of the metal wiring layer 204 is exposed. In this state, if the wafer W is left under the atmosphere or under a low vacuum, the exposed surface of the metal wiring layer 204 may be oxidized, resulting in a formation of a native metal oxide film 210 thereon. In the present embodiment, the metal wiring layer 204 is made of Cu which is highly oxidizable. Thus, the metal oxide film 210 made of CuOₓ (copper oxide) may be formed in a short time.

If the via hole 208 is filled with the metal while the metal oxide film 210 still exits, the metal oxide film 210 may be interposed between the metal wiring layer 204 and the metal buried in the via hole 208, resulting in an increase of contact resistance therebetween. In such case, fine electric characteristics of a semiconductor device formed on the wafer W may not be obtained.

For that reason, the wafer W is loaded into the processing chamber 110 of the cleaning processing apparatus 100 of the present embodiment before the process of filling the via hole 208 with the metal is performed, and a cleaning process (dry cleaning process) for removing the metal oxide film 210 is performed therein.

Such cleaning process (dry cleaning process) is carried out as follows, for example. First, the wafer W is loaded into the processing chamber 110 from the loading/unloading port 116a of the processing chamber 110 and is mounted on the mounting table 120. Then, the gate valve 134 is closed, and the wafer W is heated up to a preset temperature, e.g., 100 to 400° C. by supplying a power to the heater 128 from the heater power supply 130. Concurrently, the internal pressure of the processing chamber 110 is controlled by the gas exhaust unit 132.

When the temperature of the wafer W reaches the preset temperature and the internal pressure of the processing chamber 110 is stabilized at a certain pressure level, e.g., 0.1 Pa to 101.3 kPa, the valves 180A and 180B of the organic acid containing gas supply line 176 are opened, and an organic acid containing gas, e.g., a formic acid gas, is supplied from the organic acid containing gas supply source 172 into the first gas injection openings 150 of the shower head 140, and the formic acid gas is then injected from the first gas injection openings 150 toward the surface of the wafer W on the mounting table 120. An injection amount of the formic acid gas is controlled to, e.g., 10 to 500 sccm by the mass flow controller 182.

Further, an inert gas such as a N₂ gas may be introduced into the processing chamber 110 together with the formic acid gas. In such case, after the valves 184A and 184B of the inert gas supply line 178 are opened, the N₂ gas is supplied into the second gas injection openings 152 of the shower head 140 from the inert gas supply source 174, and then is injected from the second injection openings 152 toward the surface of the wafer W on the mounting table. An injection amount of the inert gas is controlled by the mass flow controller 186. In this way, a gaseous mixture of the formic acid gas and the N₂ gas is supplied onto the surface of the wafer W.

After the formic gas or the gaseous mixture of the formic acid gas and the N₂ gas is supplied on the surface of the wafer W, the inside of the processing chamber 110 is maintained at a preset pressure and the wafer W is heated at a preset temperature for, e.g., 30 to 300 seconds. As a result, the CuOₓ forming the metal oxide film 210 on the metal wiring layer 204 of the wafer W is converted to formate and reduced thereafter. Further, H₂O (moisture) and/or CO₂ (carbon dioxide) generated by this chemical reaction is exhausted to the outside of the processing chamber 110 by the gas exhaust unit 132.

Through the above-described cleaning process, the metal oxide film 210 formed on the surface of the metal wiring layer 204 is removed. Then, if the process of filling the via hole 208 with the metal is performed on this wafer W subsequently, fine electric characteristics can be obtained for the contact resistance between the metal wiring layer 204 and the metal in the via hole 208.

(Adhesion of Cu to the Mounting Table)

When the above-stated cleaning process is performed on the wafer W in the processing chamber 110, the CuOₓ of the metal oxide film 210 is reduced, so that Cu is generated. At this time, a part of the Cu may be dispersed from the wafer W into the space within the processing chamber 110. The majority of the dispersed Cu may reach the vicinity of the wafer W and fall down.

Accordingly, as shown in FIG. 3, given that the top surface (substrate mounting surface) of the mounting table main body 122 (i.e., the top surface of the upper cover member 124) is divided into the substrate mounting region 220, which is covered by the wafer W when the wafer W is mounted thereon and the substrate surrounding region 222 disposed outside the substrate mounting region 220 and exposed to the inside of the processing chamber, the Cu dispersed from the wafer W to the vicinity thereof is highly likely to fall down onto the substrate surrounding region 222 of the mounting table 120 while the Cu dispersed far away from the wafer W may be exhausted out by being carried by an air flow formed within the processing chamber 110. Thus, it is highly likely that the dispersed Cu is adhered to the substrate surrounding region 222 of the mounting table 120. Moreover, since a side region 224 which is a side surface of the mounting table main body 122 (i.e., a side surface of the upper cover member 124) is adjacent to the wafer W, the dispersed Cu is may also be adhered thereto even though an adhesion amount of the Cu to the side region 224 is smaller than that adhered to the substrate surrounding region 222.

In contrast, since the substrate mounting region 220 is covered by the wafer W during the cleaning process, it is very unlikely that the dispersed Cu is adhered to this region during the cleaning process.

As stated above, the Cu dispersed from the wafer W in the cleaning process may be adhered to the surface of the substrate surrounding region 222 of the upper cover member 124. If such dispersed Cu is continuously deposited thereon, an undesired Cu layer may be formed thereon. If the undesired Cu layer is formed on the upper cover member 124 of the mounting table 120, the undesired Cu layer is highly likely to be etched by organic acid during a subsequent cleaning process and adhered to an undesired portion of the wafer W again.

Thus, in the substrate processing apparatus configured to perform the cleaning process for removing the metal oxide film, there is a demand for a mounting table to which a metal component such as Cu is hardly adhered and from which the metal component can easily removed even if the metal component is adhered. This mounting table is different from a conventional mounting table which is designed to suppress peeling of a metal component adhered to the surface thereof. The mounting table 120 in accordance with the present embodiment is characterized in that surface treatment is partially performed on its surface, which is highly likely to be in contact with the metal component such as the dispersed Cu generated in the cleaning process, such that the dispersed Cu is hardly adhered to this surface and the surface has smoothness (surface roughness) capable of easily removing the metal component therefrom even if the dispersed Cu is adhered.

(Surface Treatment of the Mounting Table)

Now, the surface treatment of the mounting table in accordance with the present embodiment will be explained. In case that the upper cover member 124 (main body cover member) serving as the surface of the mounting table 120 is made of, e.g., a quartz member as described earlier, the surface of the quartz member may be treated by a sand blast method in which a treatment target surface is polished by blasting an abrasive of, e.g., No. 500 toward the treatment target surface at a preset pressure. Prior to performing the partial surface treatment in accordance with the present embodiment, a surface roughness (arithmetic average roughness) Ra of the upper cover member 124 is about 0.8 to 1.0 μm.

However, with such a level of smoothness (surface roughness), a sufficient effect of preventing adhesion of Cu to the surface of the mounting table may not be obtained as described in the conventional case. Especially, since it is highly likely that the dispersed Cu is adhered to the substrate surrounding region 222 and the side region 224 of the upper cover member 124, it is preferable that the partial surface treatment is further performed on these regions 222 and 224 to obtain higher smoothness.

In this regard, the partial surface treatment is performed on at least the substrate surrounding region 222 and the side region 224 of the upper cover member 124 in the mounting table 120 in accordance with the present embodiment. Specifically, if the partial surface treatment is conducted on the surfaces of the substrate surrounding region 222 and the side region 224 of the upper cover member 124, their surface roughnesses may be reduced to less than or equals to 1/10 of a surface roughness (e.g., surface roughness of the substrate mounting region 220) before the partial surface treatment is performed. For example, since a surface roughness Ra (arithmetic average roughness) before conducting the surface treatment is about 1.0 μm, it is preferable to perform the partial surface treatment such that their surface roughnesses (arithmetic average roughness) Ra become equal to or less than 0.1 μm.

As a specific method of the partial surface treatment (hereinafter, also referred to as a “high-smoothness surface treatment”) in accordance with the present embodiment, a fire polish (flame polish) method may be employed, for example. In this polishing method, the respective surfaces of the substrate surrounding region 222 and the side region 224 of the upper cover member 124 are exposed to a flame, whereby the quartz constituting these surfaces is softened.

Further, as for the mounting table 120 in accordance with the present embodiment, when the mounting table main body 122 has only the main body plate 123 without the upper cover member 124, the partial surface treatment as described above may be performed on a top and a side surface region of the main body plate 123, which are corresponding to the substrate surrounding region 222 and the side region 224 of the upper cover member 124, respectively.

In case of the mounting table 120 in accordance with the present embodiment as described above, the partial surface treatment is performed to further smoothen parts of the top surface of the mounting table main body 122 (e.g., the substrate surrounding region 222 and the side region 224), which are exposed without being covered by the wafer W. Thus, when the cleaning process is performed to remove the metal oxide film such as copper oxide on the wafer W, the metal component such as copper generated by the reduction of the metal oxide film may be suppressed from being easily adhered to the surface region with which the metal component tends to contact even though the metal component is dispersed thereto.

As a result, the effect of preventing adhesion of the metal component improves, so that formation of an undesired metal layer such as a Cu layer on each surface of the substrate surrounding region 222 and the side region 224 of the upper cover member 124 can be suppressed even when the cleaning process for the wafer W is repeatedly performed.

Thus, compared to conventional cases, the frequency of maintenance of the cleaning processing apparatus 100 for removing a deposit on the surface of the mounting table 120 can be greatly reduced. Such reduction of the maintenance frequency for the cleaning processing apparatus 100 leads to an improvement of throughput in the manufacture of wafers W.

Further, since surface smoothness of each of the substrate surrounding region 222 and the side region 224 of the upper cover member 124 is high, the metal component such as Cu can be easily removed even if it is adhered to such regions. That is, in the maintenance of the cleaning processing apparatus 100, Cu adhered to the surfaces of the substrate surrounding region 222 and the side region 224 can be easily removed. At this time, Cu can be readily washed away by using, e.g., ethanol or pure water without having to use any special liquid chemical. Therefore, the time required for the maintenance of the cleaning processing apparatus 100 can be reduced, and the throughput for the manufacture of wafers W can be further improved.

Moreover, in the present embodiment, since the surface treatment is partially performed only on the mounting table 120′s surface portion (e.g., the substrate surrounding region 222 and the side region 224 of the upper cover member 124) to which the floating metal component such as Cu is can be easily adhered, manufacturing cost of the mounting table 120 can be greatly reduced compared to a case of performing a same surface treatment on the entire surface of the mounting table 120.

Now, a result of an experiment conducted to observe an effect of the mounting table in accordance with the present embodiment will be explained. In this experiment, a cleaning process was performed by using the cleaning processing apparatus 100 to reduce and remove a copper oxide film formed on a wafer W by way of supplying a gaseous mixture of a formic acid gas and a N₂ gas onto the wafer W mounted on the mounting table 120.

Here, an upper cover member A made of quartz and having a substrate surrounding region on which the surface treatment is being performed by a fire polish (flame polish) method; and an upper cover member B made of quartz without performing the surface treatment thereon are prepared. By using mounting tables on which the upper cover members A and B are respectively installed, a cleaning process was performed repeatedly on a plurality of wafers W consecutively. Then, the upper cover members A and B were taken out, and adhesion state of Cu on their substrate surrounding regions was investigated.

In the experiment, Cu deposits were observed on the substrate surrounding regions of both of the upper cover members A and B with naked eyes. However, the adhesion amount of Cu deposits on the upper cover member A treated by the surface treatment was much smaller than the amount of Cu deposits on the upper cover member B not treated by the surface treatment.

Moreover, the adhesion of the Cu deposits on the upper cover member B was so strong that the Cu deposits could not be washed away just by ethanol or pure water. Besides, the Cu deposits could not be easily removed even with a special liquid chemical, and it took as much as 30 minutes or more to remove all the Cu deposits when observed with naked eyes.

In contrast, the adhesion of the Cu deposits on the upper cover member A was so weak that they could be removed by ethanol or pure water, and could be more easily washed away when a special liquid chemical is used. In this case, it took only 30 seconds or less to complete the removal of all the Cu deposits when observed with naked eyes. That is, it was found that in case that the surface treatment was performed, all the Cu deposits could be removed in a very short period of time which is equal to or less than 1/60 of the time period required in case that the surface treatment was not performed.

According to the experiment as described above, it was proved that when the surface treatment was performed on the upper cover member, the amount of Cu deposits adhered to the upper cover member's portion treated by the surface treatment can be reduced compared to that in case without performing the surface treatment. It was also found out that even if the Cu deposits are adhered to the portion of the upper cover member treated by the surface treatment, they can be very easily removed.

Further, in the present embodiment, although the partial surface treatment (high-smoothness surface treatment) was conducted on the respective surfaces of the substrate surrounding region 222 and the side region 224 among the entire surface of the upper cover member 124, the present invention is not limited thereto. For example, it may be also possible to perform the partial surface treatment (high-smoothness surface treatment) only on the surface of the substrate surrounding region 222 to which the dispersed Cu is most likely to be adhered, depending on the pattern of adhesion of the dispersed Cu. In such case, an increase of cost accompanied by the high-smoothness surface treatment in accordance with the present embodiment can be minimized while effectively preventing adhesion of the dispersed Cu to the surface of the mounting table.

Moreover, as illustrated in FIG. 3, the stepped portion 124a is formed at the top surface (substrate mounting surface) of the upper cover member 124 (main body cover member) such that a region on which the wafer W is mounted is lower than its surrounding region. In such case, if the lower region is slightly larger than the size of the wafer W, an area of the lower region outside the wafer W and a surface of the stepped portion 124a may also be regarded as the substrate surrounding region 222, and it may be possible to perform thereon the high-smoothness surface treatment of the present embodiment.

Since the surface of the upper cover member 124 in accordance with the present embodiment is made of quartz, the above-described fire polish method can be employed for the high-smoothness surface treatment. On the contrary, if the surface of the upper cover member 124 is made of aluminum (Al) or an Al compound such as alumina, high surface smoothness can be obtained by performing, for example, a nonporous anodic oxidation process. More specifically, an OGF (Out Gas Free; registered trademark) surface treatment may be employed. By the OGF surface treatment, an Al₂O₈ composition film having a thickness of about 7000 Å (angstrom) is formed on a treated surface. The film thus obtained features a small outgassing amount (no greater than about 1/10 of a general alumite film) as well as very high surface smoothness. Further, thermal shock resistance or plasma corrosion resistance of the treated surface can also be improved.

The high-smoothness surface treatment may also be performed on various components within the processing chamber 110 such as the ceiling wall 112, the bottom wall 114, the sidewall 116 and the shower head 140. In case that these components are made of Al, the above-mentioned OFG surface treatment may be employed. Typically, the surfaces of the components within the processing chamber 110 have been mechanically polished, and a surface roughness Ra (arithmetic average roughness) of, e.g., the shower head 140 is in the range from about 1.3 to 1.8 μm. However, by performing the OGF surface treatment on the surface of this shower head 140, a higher level of smoothness can be obtained, so that adhesion of dispersed Cu can be effectively prevented.

Moreover, although the mounting table 120 in accordance with the present embodiment includes the upper cover member 124 and the lower cover member 126, the present invention may be applied to a mounting table without having these cover members. In such case, it is preferable to directly perform the high-smoothness surface treatment on a surface of a substrate mounting region and a side surface of the mounting table.

Further, although the mounting table 120 in accordance with the present embodiment includes two kinds of cover members (the upper cover member 124 and the lower cover member 126), the present invention may also be applied to a mounting table having three or more kinds of cover members. Examples of the three cover members may be a cover member covering the top surface of the mounting table main body 122; a cover member covering the side surface of the mounting table main body 122; and a cover member covering the bottom surface of the mounting table main body 122 and the surface of the supporting column 125. In case of such a mounting table having multiple kinds of cover members, it is preferable to select cover members depending on Cu dispersion state and to perform the high-smoothness surface treatment on the selected cover members.

Though the metal wiring layer 204 is made of Cu in the above-described embodiment, the present invention may also be applied to a case where the metal layer 204 may be formed of Ag (silver), Co (cobalt), Ni (nickel), Mn (manganese), or the like.

Further, in accordance with the present embodiment of the present invention, the mounting table is applied to the apparatus configured to perform the cleaning process for removing the metal oxide film 210 on the surface of the metal wiring layer 204 exposed in the opening formed by etching the interlayer dielectric film 206, the present invention is not limited thereto. The present invention may also be applied to a mounting table of an apparatus configured to perform another kind of cleaning process, e.g., a cleaning process for removing an oxide film formed on a metal surface after CMP (Chemical-mechanical polishing) is carried out.

Further, the mounting table in accordance with the present embodiment may be applied to not only the cleaning processing apparatus configured to perform the cleaning process but also a film forming apparatus configured to perform a film forming process for forming a metal film (e.g., a Cu film) on a substrate.

In such a film forming apparatus, a metal film such as a Cu film on a wafer W is formed by, e.g., a CVD (Chemical Vapor Deposition), a PVD (Physical Vapor Deposition) method, or the like. For example, in a film forming process for forming the Cu film by the CVD method, the wafer W is heated to a certain temperature (e.g., 100 to 300° C.), and a thin Cu film is formed on the surface of the wafer W by supplying a preset processing gas on the wafer W. In such case, a gas containing copper hexafluoroacetylacetonate trimethylvinylsilane (Cu(hfac)TMVS) as a source gas; a hydrogen gas (H₂) as a reducing gas for the Cu(hfac)TMVS; and an argon gas (Ar) as an inert gas may be used as the processing gas. In such film forming process, Cu is also adhered to the surface of the mounting table as well as to the surface of the wafer W. Thus, a problem of metal contamination may occur, as in the case of the cleaning process.

That is, if the film forming process is repeatedly performed without removing a metal deposit on the surface of the mounting table, the metal deposit may be peeled off from the surface of the mounting table, resulting in particle generation. Thus, the metal deposit on the mounting table surface needs to be removed periodically. In the conventional mounting table on which the surface treatment in accordance with the present embodiment is not performed, a cleaning process has taken a long time because removal of the metal deposit is not easy.

In contrast, by applying the mounting table treated by the surface treatment in accordance with the present embodiment to the film forming apparatus, an adhesion of metal component can be suppressed during the film forming process, and they can be very easily removed even if the metal component is adhered. Accordingly, the frequency of mounting table cleaning process can be reduced, and the time for completing the mounting table cleaning process can also be shortened.

Further, it may be also possible to use the apparatus shown in FIG. 1 as a film forming apparatus. In such case, the gas supply unit 170 may further include, for example, one more gas supply system for supplying a source gas into the processing chamber 110 via a vaporizer (not shown) in addition to the dual gas supply system shown in FIG. 1. For example, the source gas such as Cu(hfac)TMVS may be supplied via the vaporizer, and a H₂ gas as a reducing gas may be supplied from the organic acid containing gas supply source 172 instead of the organic acid containing gas, and an Ar gas may be supplied from the inert gas supply source 174. Here, though the example has been described for the case of performing the film forming process without exciting plasma, the present invention may also be applied to a case of performing a film forming process by exciting plasma.

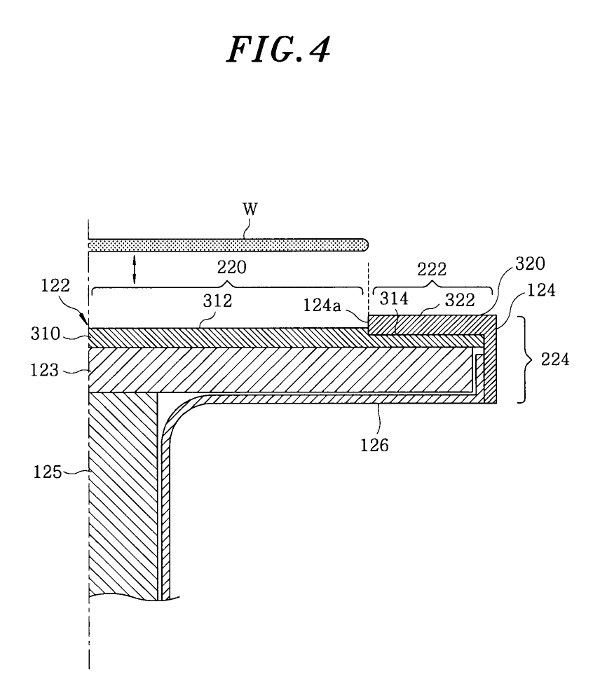

Moreover, in the above-described embodiment, though the upper cover member 124 is configured to have the substrate mounting region 220 and the substrate surrounding region 222 thereon as shown in FIG. 3, the present invention is not limited thereto. For example, it may be also possible to constitute the upper cover member 124 with a first cover member 310 forming the substrate mounting region 220 and a second cover member 320 forming the substrate surrounding region 222 as illustrated in FIG. 4.

To be more specific, the first cover member 310 is formed in, e.g., a circular plate shape covering the top surface of the main body plate 123. The top surface of the first cover member 310 includes a substrate mounting surface 312 having the substrate mounting region 220 and an extended surface 314 extended outward from the substrate mounting surface 312 to surround it. The extended surface 314 is depressed lower than the substrate mounting surface 312, and the second cover member 320 is formed so as to cover the extended surface 314 and the side surface of the main body plate 123. The top surface of the second cover member 320 serves as a substrate surrounding surface 322 having the substrate surrounding region 222.

As described, by constituting the upper cover member 124 with the first cover member 310 and the second cover member 320, the above-described high-smoothness surface treatment can be easily performed on the substrate surrounding surface 322. Further, the high-smoothness surface treatment can also be easily performed on the substrate mounting surface 312 as well as on the substrate surrounding surface 322. Accordingly, since the high-smoothness surface treatment can be performed on both the substrate surrounding region 222 and the substrate mounting region 220, metal component such as Cu is hardly adhered to the substrate mounting region 220 even if the metal component is dispersed into a space between the wafer W and the substrate mounting region 220, and can be easily removed even if adhered.

When a film forming process for forming a metal film such as Cu or the like is performed by, e.g., a CVD method, a source gas containing metal and a reducing gas are supplied onto a wafer W mounted on the mounting table 120, and a film is formed on the substrate by a reduction of the metal. Thus, the metal such as Cu is easily deposited on the substrate surrounding surface 322 and is also easily dispersed into a space between the wafer W and the substrate mounting surface 312. Thus, in the substrate processing apparatus that performs such a film forming process, it is preferable to perform the high-smoothness surface treatment on the substrate mounting surface 312 as well as the substrate surrounding surface 322.

Further, the above-stated high-smoothness surface treatment may be also performed on the side surface of the second cover member 320 and on the surface of the stepped portion 124a of the second cover member 320.

Moreover, in case that a mounting table does not have these cover members, the mounting table may be made up of a first member having a substrate mounting surface 312 serving as a substrate mounting region 220 for mounting a wafer W thereon and a second member having a substrate surrounding surface 322, which is provided to surround the substrate mounting surface 312 and serves as a substrate surrounding region 222 outside the substrate mounting surface 312. In such case, it may be preferable to directly perform the above-described high-smoothness surface treatment on the substrate mounting surface 312 of the first member as well as on the substrate surrounding surface 322 of the second member. Moreover, the high-smoothness surface treatment may also be performed on the side surface of the second member.

While the invention has been shown and described with respect to the embodiment in connection with the accompanying drawings, the present invention is not limited thereto. It would be understood by those skilled in the art that various changes and modifications may be made without departing from the scope of ideas disclosed in the claims.

### INDUSTRIAL APPLICABILITY

The present invention has many advantages when it is applied to a substrate processing apparatus, a substrate mounting table and a method for treating a surface of the substrate mounting table.

1. A substrate mounting table of a substrate processing apparatus that performs a cleaning process of removing a metal oxide film on a surface of a metal film formed on a substrate, comprising:
a mounting table main body for mounting the substrate thereon,
wherein a top surface of the mounting table main body includes a substrate mounting region, which is covered by the substrate when the substrate is mounted on the mounting table main body, and a substrate surrounding region, which is disposed outside the substrate mounting region and has a surface treated by a partial surface treatment such that the substrate surrounding region is smoother than the substrate mounting region.

2. A substrate mounting table of a substrate processing apparatus that performs a cleaning process of removing a metal oxide film on a surface of a metal film formed on a substrate, comprising:
a mounting table main body, at least a top surface of which is covered with a cover member,
wherein a top surface of the cover member includes a substrate mounting region, which is covered by the substrate when the substrate is mounted on the cover member, and a substrate surrounding region, which is disposed outside the substrate mounting region and has a surface treated by a partial surface treatment such that the substrate surrounding region is smoother than the substrate mounting region.

3. (canceled)

4. The substrate mounting table of claim 1 or 2, wherein a surface roughness Ra, which is an arithmetic average roughness, of the surface treated by the partial surface treatment is equal to or less than 0.1 μm.

5. The substrate mounting table of claim 1 or 2, wherein the surface treated by the partial surface treatment is made of a quartz member having a surface treated by a fire polish process.

6. The substrate mounting table of claim 1 or 2, wherein the surface treated by the partial surface treatment is made of an aluminum member having a surface treated by a nonporous anodic oxidation process.

7. The substrate mounting table of claim 1, wherein the mounting table main body includes a side surface treated by the partial surface treatment such that the side surface of the mounting table main body has a surface roughness identical to that of the substrate surrounding region.

8. The substrate mounting table of claim 2, wherein a side surface of the mounting table main body is also covered by a side portion of the cover member and the side portion of the cover member has a surface treated by the partial surface treatment such that the surface of the side portion of the cover member has a surface roughness identical to that of the substrate surrounding region.

9. The substrate mounting table of claim 1 or 2, wherein the cleaning process is performed in a gaseous atmosphere.

10. A substrate processing apparatus for performing a cleaning process for removing a metal oxide film on a surface of a metal film formed on a substrate, comprising:
a vacuum evacuable processing chamber;
a substrate mounting table installed in the processing chamber; and
a gas supply unit for supplying at least a cleaning processing gas into the processing chamber; and
a gas inlet unit, installed in the processing chamber, for introducing a gas from the gas supply unit toward the substrate on the mounting table,
wherein the substrate mounting table includes a mounting table main body for mounting the substrate thereon, and
wherein a top surface of the mounting table main body includes a substrate mounting region, which is covered by the substrate when the substrate is mounted on the mounting table main body, and a substrate surrounding region, which is disposed outside the substrate mounting region and has a surface treated by a partial surface treatment such that the substrate surrounding region is smoother than the substrate mounting region.

11. A substrate processing apparatus for performing a cleaning process for removing a metal oxide film on a surface of a metal film formed on a substrate, comprising:
a vacuum evacuable processing chamber;
a substrate mounting table installed in the processing chamber; and
a gas supply unit for supplying at least a cleaning processing gas into the processing chamber; and
a gas inlet unit, installed in the processing chamber, for introducing a gas from the gas supply unit toward the substrate on the mounting table,
wherein the substrate mounting table includes a mounting table main body, at least a top surface of which is covered by a cover member, and
wherein a top surface of the cover member includes a substrate mounting region, which is covered by the substrate when the substrate is mounted on the cover member, and a substrate surrounding region, which is disposed outside the substrate mounting region and has a surface treated by a partial surface treatment such that the substrate surrounding region is smoother than the substrate mounting region.

12. The substrate processing apparatus of claim 10 or 11, wherein the metal film contains copper and the cleaning processing gas is an organic acid containing gas.

13. The substrate processing apparatus of claim 10 or 11, wherein a processing chamber inner wall has a surface exposed to an inside of the processing chamber, and the surface is made of an aluminum member having a surface treated by a nonporous anodic oxidation process.

14. The substrate processing apparatus of claim 10 or 11, wherein the gas inlet unit has a surface exposed to an inside of the processing chamber, and the surface is made of an aluminum member having a surface treated by a nonporous anodic oxidation process.

15-20. (canceled)

21. A substrate mounting table of a substrate processing apparatus for performing a film forming process for forming a metal film on a substrate or a cleaning process for removing a metal oxide film on the metal film, comprising:
a first member having a substrate mounting surface for mounting the substrate thereon; and
a second member, installed to surround the substrate mounting surface, having a substrate surrounding region disposed outside the substrate mounting region,
wherein the substrate mounting surface and the substrate surrounding surface are treated by a partial surface treatment such that their surface roughnesses Ra, which is an arithmetic roughness, are equal to or less than 0.1 μm.

22. A substrate mounting table of a substrate processing apparatus for performing a film forming process for forming a metal film on a substrate or a cleaning process for removing a metal oxide film on the metal film, comprising:
a mounting table main body, at least a top surface of which is covered with a cover member,
wherein the cover member includes:
a first cover member having a substrate mounting surface for mounting the substrate thereon; and
a second cover member, installed to surround the substrate mounting surface, having a substrate surrounding surface disposed outside the substrate mounting surface,
wherein the substrate mounting surface and the substrate surrounding surface are treated by a partial surface treatment such that their surface roughnesses Ra, which is an arithmetic roughness, are equal to or less than 0.1 μm.

23. The substrate mounting table of claim 21 or 22, wherein each of the surfaces treated by the partial surface treatment is made of a quartz member having a surface having a surface treated by a fire polish process.

24. The substrate mounting table of claim 21 or 22, wherein each of the surfaces treated by the partial surface treatment is made of an aluminum having a surface treated by a nonporous anodic oxidation process.

25. The substrate mounting table of claim 21, wherein
the second member of the substrate mounting table includes a side surface treated by the partial surface treatment such that the side surface of the second member of the substrate mounting table has a surface roughness identical to that of the substrate surrounding region.

26. The substrate mounting table of claim 22, wherein a side surface of the mounting table main body is also covered by a side portion of the second cover member and the side portion of the second cover member has a surface treated by the partial surface treatment such that the surface of the side portion of the second cover member has a surface roughness identical to that of the substrate surrounding region.
